(19) United States
(12) Patent Application Publication
(10) Pub. No.: US 2012/0177396 A1
(43) Pub. Date: Jul. 12, 2012

(54) EMISSION CONTROL FOR AN ELECTROPHOTOGRAPHIC PRINTER

(76) Inventors: Jeffrey A. Pitas, Macedon, NY (US); Gary P. Lawniczak, Rochester, NY (US); Matthias H. Regelsberger, Rochester, NY (US)

(21) Appl. No.: 13/004,109

(22) Filed: Jan. 11, 2011

(51) Int. Cl. G03G 21/20

(52) U.S. Cl. 399/93

(57) ABSTRACT

An electrophotographic apparatus includes a photoconductor; a charging device for placing a uniform charge on the photoconductor; an image writer for writing an image on the charged photoconductor; a developer station for developing the image with toner; a transfer station for transferring the toned image to a receiver; a fixing unit for fusing the image to the receiver; environmental control system for removing airborne contaminants from the electrophotographic apparatus; the environmental control system includes a catalytic filter; and ozone is added prior to the catalytic filter when the contaminant is formaldehyde.

### CROSS REFERENCE TO RELATED APPLICATIONS

Reference is made to commonly-assigned copending U.S. patent application Ser. No. ______ (Attorney Docket No. 96698), filed herewith, entitled METHOD OF CONTROLLING EMISSIONS IN AN ELECTROPHOTOGRAPHIC PRINTER, by Pitas et al.; the disclosure of which is incorporated herein.

### FIELD OF THE INVENTION

This invention relates in general to the field of electrophotography and in particular to removing waste products generated by electrophotography.

### BACKGROUND OF THE INVENTION

The electrophotographic process is used as a means of creating an image on paper or other suitable printing media. The electrophotographic process uses various components assembled into a print engine to enable printing. Energy consumed by the printer is converted to heat which must be eliminated from the printer to enable function.

In addition, the electrophotographic process generates contaminants which may adversely affect the printer and the external environment. Some of the byproducts of the electrophotographic process include ozone and formaldehyde and heat from the image fixing process. Other contaminants include paper dust.

Previous attempts to remove contaminants have included particulate filters, ozone filters, aldehyde filters, in combination with cooling fans, ductwork, and temperature sensors. All of these processes, while sometimes reducing the amount of contamination, have various inefficiencies. For example, a catalytic filter used for removing formaldehyde easily becomes clogged with contaminants produced by breaking down the formaldehyde. Replacement of the filter is expensive and time consuming.

A means to control heat and emissions from an electrophotographic printer while improving inefficiencies seen with other designs would be desirable.

### SUMMARY OF THE INVENTION

Briefly, according to one aspect of the present invention an electrophotographic apparatus includes a photoconductor; a charging device for placing a uniform charge on the photoconductor; an image writer for writing an image on the charged photoconductor; a developer station for developing the image with toner; a transfer station for transferring the toned image to a receiver; a fixing unit for fusing the image to the receiver; and environmental control system for removing airborne contaminants from the electrophotographic apparatus.

The invention and its objects and advantages will become more apparent in the detailed description of the preferred embodiment presented below.

### BRIEF DESCRIPTION OF THE DRAWINGS

FIG. 1 is a perspective view of a electrophotographic print module.

FIG. 2 is a cross-sectional schematic view of an electrophotographic print module.

FIG. 3 is a cross-sectional schematic view of a fuser device.

FIG. 4 is a perspective view of an electrical module.

FIG. 5 is a perspective view showing air paths within an electrophotographic print module.

FIG. 6 is a perspective view showing air paths within an electrophotographic print module.

FIG. 7 is a schematic view of an ozone generator.

FIG. 8 is a schematic view of an air mixing duct.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

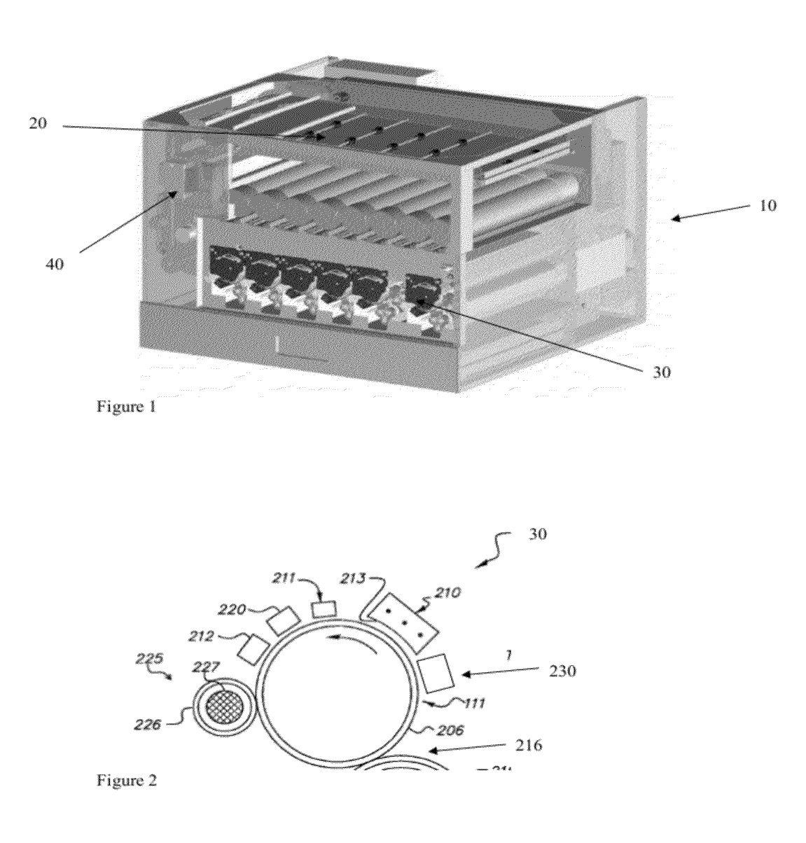

Referring now to FIG. 1, an electrophotographic printer 10 includes all components necessary to accomplish the task of printing an image on paper. A printer is comprised of various sub-assemblies which perform specific functions. An imaging module 30 performs the function of electrostatically creating an image with toner and transferring this to paper. A fuser module 40 performs the function of fixing the toner permanently to paper. A paper path 20 performs the function of transporting paper from a paper source to transfer point and fusing zone and subsequently exits the printer. Electrical hardware provides the electrical energy to perform tasks required by the modules.

Referring now to FIG. 2 an imaging module 30 is shown. Multiple modules may be assembled to enable the printing of multiple color images. Primary charging subsystem 210 uniformly electrostatically charges photoreceptor 206 of photoreceptive member 111, shown in the form of an imaging cylinder. Charging subsystem 210 may include a grid 213 having a selected voltage, or may be in the form of a roller with conductive properties.

Additional necessary components provided for control may be assembled around the various process elements of the respective printing modules. Meter 211 measures the uniform electrostatic charge provided by charging subsystem 210, and meter 212 measures the post-exposure surface potential within a patch area of a latent image formed from time to time in a non-image area on photoreceptor 206. Image writer 220 is used to expose photoreceptor 206 and may be a light emitting diode (LED) array or other similar mechanism. Toning unit 225, comprising elements 226 and 227 is used to develop the latent image created by image writer 220 on photoreceptor 206. Cleaning unit 230 removes residual toner from photoreceptor 206 after transfer of the image to secondary receiver 216. Other meters and components may be included.

Within the imaging module heat is generated at the image writer 220, which must be eliminated to limit thermal expansion which can cause image distortion and for stability in the electrophotographic process. Dust is generated by toning unit 225, which needs to be removed in order to prevent accumulation on surfaces which could subsequently become dislodged and spoil images.

Charging subsystem 210 creates ozone which also must be exhausted from the module. Excessive ozone levels within the electrophotographic engine may cause degradation of imaging members.

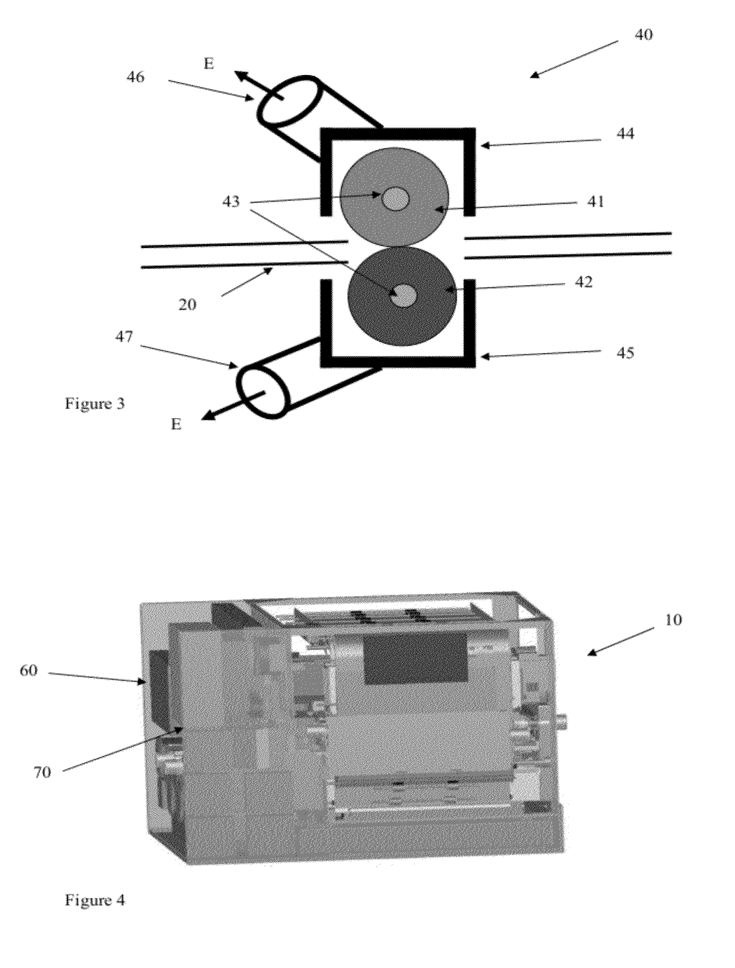

Referring now to FIG. 3, a fuser module 40 is shown. Within the fuser module are fuser roller 41, pressure roller 42, and lamps 43. A high pressure nip is formed between the pressure roller and fuser roller. Heat is applied with the lamps. Paper with transferred image enters the nip formed between the fuser roller and pressure roller from paper path 20. Rollers may be replaced with belts for some designs. The combination of heat and applied pressure fuses the toner onto the paper. Not all the heat that is generated by the lamps is transferred to paper. Residual heat will quickly overheat the printer unless a cooling means is used. Chemical emissions from heated paper, toner, and any oils used to aid the fusing process must be eliminated from the exhaust airstream. An emission of particular concern from the fuser module is formaldehyde. Heat from the fusing process can release formaldehyde from papers being printed and from chemicals used by the electrophotographic printer. Plenums 44 and 45 contain formaldehyde contaminated air E, and duct 46 and duct 47 direct contaminated air to a collection point.

Referring now to FIG. 4, an electrical module is shown. The electrical module consists of various power supplies needed to provide power to the printer 10, such as transfer power supply 60 and fuser lamp power supply 70. Heat is generated within the electrical module which must be dissipated to prevent overheating of supplies. A means of cooling is required to prevent overheating the electrical module.

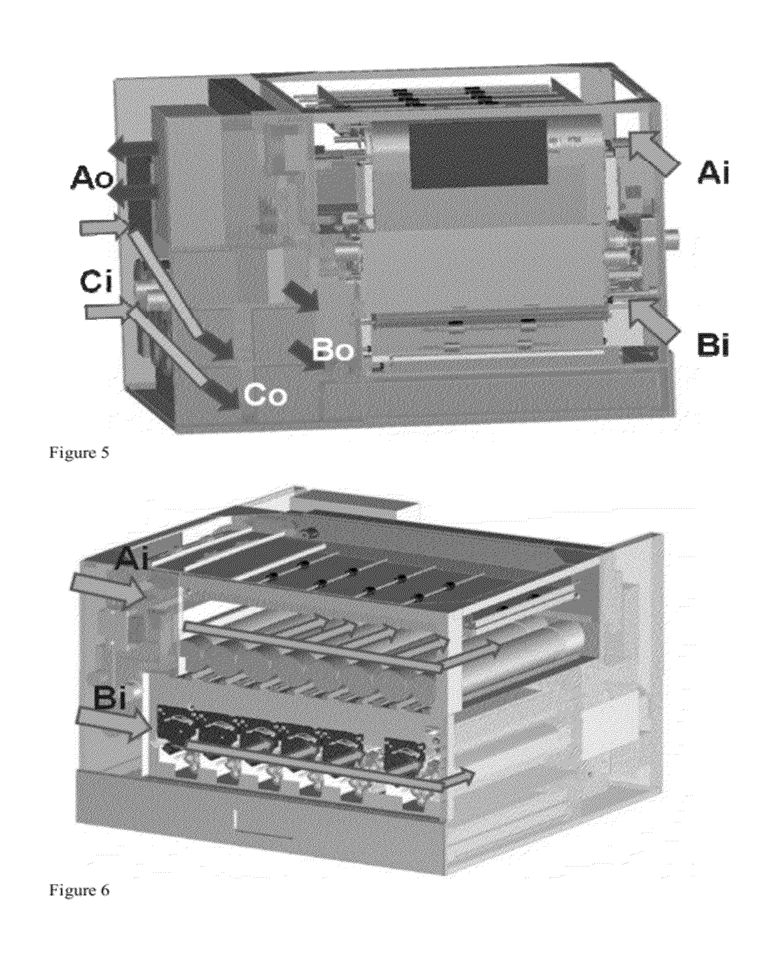

Referring now to FIGS. 5 and 6, a printer with distributed control zone strategy is shown. Three defined control zones, marked as A, B, C, with dedicated fans for each control zone are shown. Additional fans may be added to each cooling zone as convenient to the particular design. In this configuration, inlet air is pulled through the printer through ducts to each of the areas to be cooled and exited through the rear portion of the printer. Particulate filters on the inlet air are placed at the openings. The purpose of providing dedicated control zones within the printer is that the contaminants produced and thermal conditioning requirements are different for each area. Air is exhausted from the printer by pulling air through the system, such that a vacuum is created within the machine which helps to control machine emissions by directing contaminated airstreams through filters.

An approach for determining airflow for cooling within office products is to make the assumption that all energy consumed is converted to heat. When energy consumed within an area of the printer is known, and acceptable temperature rise is known, airflow may be determined.

The imaging module has low energy consumption components, but is quite sensitive to temperature change. A fuser module is least sensitive to temperature change, but has high energy consumption. An electronics module can tolerate a reasonable temperature increase and has medium energy consumption. The mismatch in thermal requirements is most efficiently dealt with by the use of separate control zones using dedicated ducts and cooling fans. Using dedicated ducts and fans allows optimized filtration to address emissions particular to those produced within the zone. Dedicated air paths allow filters to be placed on or adjacent to external covers surface making for easy service.

An approach commonly used is to use a single fan with ducts tuned to provide a particular airflow to each control zone of the equipment. In practice, it is difficult to optimize the flow of each branch circuit, generally resulting in an overly large fan to compensate for inefficiency. Generally for these systems, filters are placed in ducts between the area being controlled and the fan making them difficult to service.

An alternate approach used is to use a single large fan without attempt for zone cooling. This is an extremely inefficient means of controlling temperature and contaminants. With no dedicated airflow path, the airflow must be increased to a level which would allow acceptable temperature rise for the entire machine to be limited to that of the most thermally sensitive area of the equipment. This also requires filtering the entire airstream for emissions, which leads to large expensive filters.

The optimum strategy, therefore, for temperature and emission control is the use of dedicated control zones within the printer. Once having established the optimum strategy an efficient means of controlling chemical emissions can be established.

Catalytic filters are used to decompose formaldehyde within formaldehyde laden air from the fuser process into harmless materials. Catalytic filters are also commonly used to decompose ozone within ozone laden air from charging subsystems into harmless materials. Catalytic materials are used in electrophotographic print engines so that the filter life should meet or exceed the life of the product they are used in, thus eliminating the need for service. Non-catalytic filter material may be used, however, these require frequent service thus increasing service costs. A known issue with formaldehyde catalytic filters is that they quickly lose efficiency and are rendered useless unless ozone is present as a catalytic filter renewal agent. A solution to this problem is to introduce ozone into a formaldehyde laden airstream where it might otherwise normally not be present.

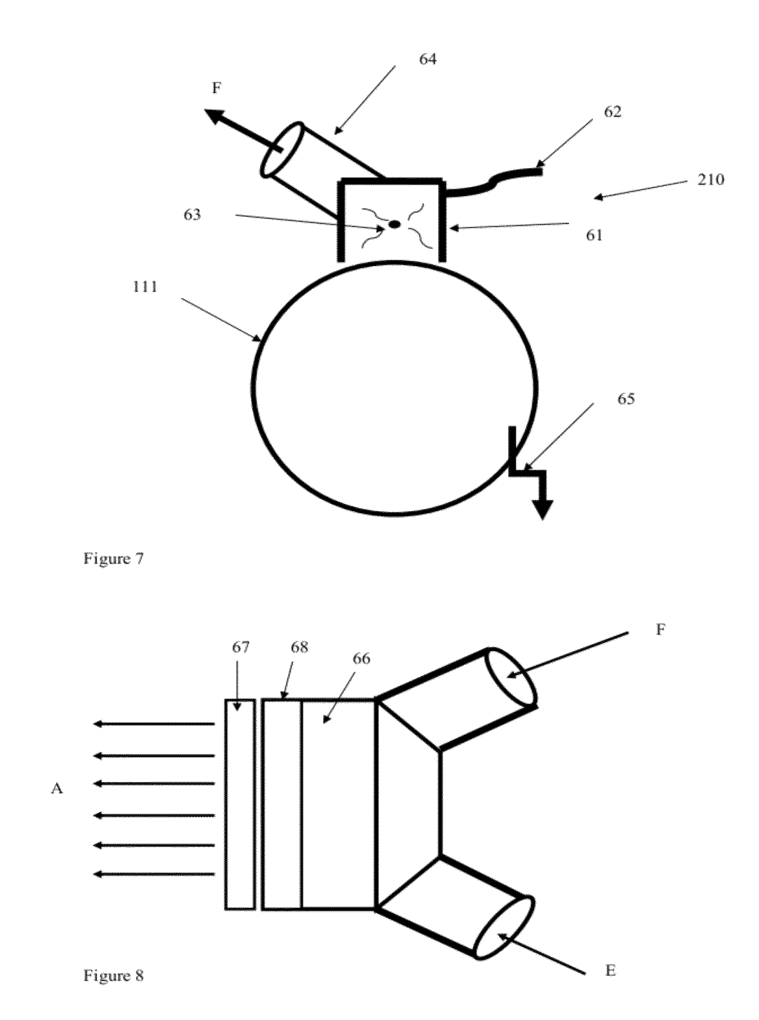

Referring now to FIG. 7 is shown an ozone generator which may be a charging subsystem 210 in an electrophotographic print module, or it may be a electrostatic charger to enable removal of excessive electrostatic charge from paper to enable detack, or it may be a device purposely introduced into the electrophotographic print engine for the sole purpose of generating ozone. The charging subsystem 210 is comprised of charger shell 61, charger wire 63, and high voltage contact 62. A scavenging duct 64 is used to gather ozone generated from said ozone generator. Ozone laden air F is directed from scavenging duct 64 with additional ductwork to a mixing point. The photoreceptive member 111 is coupled with ground 65. The photoreceptive member may be replaced with a metal plate to act as an ozone generator.

Referring now to FIG. 8 is shown a means to combine the airstream from fuser module and from ozone generator. A fan 67 and ductwork 66 convenient to the particular design is arranged to channel and mix the ozone containing air E, in adequate quantity to enable the renewal of the catalytic filter, with the formaldehyde laden air F. A catalytic filter 68 is arranged within the ductwork. Treated air exits the electrophotographic print engine at A. Having thus introduced ozone not normally present in the formaldehyde laden airstream, the filter life is extended to meet service expectations.

The invention has been described in detail with particular reference to certain preferred embodiments thereof, but it will be understood that variations and modifications can be effected within the scope of the invention.

### PARTS LIST

10 electrophotographic printer
20 paper path
30 imaging module
40 fuser module
41 fuser roller
42 pressure roller
43 lamp
44 plenum
45 plenum
46 duct
47 duct
60 power supply
61 charger shell
62 high voltage contact
63 charger wire
64 scavenging duct
65 ground
66 ductwork
67 fan
68 catalytic filter
70 fuser lamp power supply
111 photoreceptive member
206 photoreceptor
210 charging subsystem
211 meter
212 meter
213 grid
216 secondary receiver
220 image writer
225 toning unit
226 element
227 element
230 cleaning unit

1. An electrophotographic apparatus comprising:
a photoconductor;
a charging device for placing a uniform charge on the photoconductor;
an image writer for writing an image on the charged photoconductor;
a developer station for developing the image with toner;
a transfer station for transferring the toned image to a receiver;
a fixing unit for fusing the image to the receiver; and
environmental control system for removing airborne contaminants from the electrophotographic apparatus.

2. The electrophotographic apparatus of claim 1 wherein the contaminants are formaldehyde, ozone, toner particles, and paper dust.

3. The electrophotographic apparatus of claim 1 wherein the environmental control system comprises:
a catalytic filter.

4. The electrophotographic apparatus of claim 3 wherein ozone is added prior to the catalytic filter when the contaminant is formaldehyde.

5. The electrophotographic apparatus of claim 4 wherein the ozone is generated as part of the electrophotographic process.

6. The electrophotographic apparatus of claim 4 wherein the ozone is generated by an ozone generator.

7. The electrophotographic apparatus of claim 3 wherein the filter further comprises a particulate filter.

8. The electrophotographic apparatus of claim 5 wherein the ozone generated by the electrophotographic process is conducted from the charger to the environmental control system by ductwork or a fan or a combination thereof.

9. The electrophotographic apparatus of claim 5 wherein the ozone is generated by a corona charger used to detack paper, condition paper, uniformly charge the photoconductor or to enable transfer of the image.
